(19) United States
(12) Patent Application Publication
(10) Pub. No.: US 2016/0054843 A1
(43) Pub. Date: Feb. 25, 2016

(54) TOUCH PAD SYSTEM AND PROGRAM FOR TOUCH PAD CONTROL

(71) Applicant: ALPS ELECTRIC CO., LTD., Tokyo (JP)

(72) Inventor: Kenji WATANABE, Miyagi-ken (JP)

(21) Appl. No.: 14/703,680

(22) Filed: May 4, 2015

(30) Foreign Application Priority Data
Aug. 25, 2014 (JP) 2014-170981

(51) Int. Cl. G06F 3/041

(52) U.S. Cl. CPC G06F 3/0416

(57) ABSTRACT

A touch pad system includes an operation member, coordinate output means, pressing detection means, and control means, and the control means determines the presence or absence of a slide operation from a change in the coordinate output that is output from the coordinate output means, sets a first area in which execution of a first function is determined when a pressing operation is performed with respect to the operation member, and a second area in which execution of the first function or a second function is determined when the pressing operation is performed, and executes the first function if the slide operation is performed prior to the pressing operation and the second function if the slide operation is not performed when the pressing operation is performed in the second area.

### CLAIM OF PRIORITY

This application claims benefit of Japanese Patent Application No. 2014-170981 filed on Aug. 25, 2014, which is hereby incorporated by reference.

### BACKGROUND OF THE INVENTION

1. Field of the Invention

The present invention relates to a touch pad system and a program for touch pad control, and more particularly, to a touch pad system and a program for touch pad control with good operability.

2. Description of the Related Art

Conventionally, in a notebook type portable computer (hereinafter referred to as a notebook PC), a touch pad device in which a touch pad with respect to which a proximity operation can be performed with an operation body such as a finger of an operator, a right button, and a left button are combined is widely used as an input device.

In recent years, so as to increase an area of a touch pad as an input operation such as an operation input performed by a plurality of fingers is diversified, an input device in which a right button and a left button of the related art are replaced with a pseudo button set on the touch pad has been proposed.

A touch pad described in Japanese Unexamined Patent Application Publication No. 2013-25422 below is known as a touch pad of the related art. Hereinafter, a touch pad 900 described in Japanese Unexamined Patent Application Publication No. 2013-25422 will be described using FIGS. 7A and 7B. FIGS. 7A and 7B are diagrams illustrating a structure of the touch pad 900, FIG. 7A is a plan view of the touch pad 900, and FIG. 7B is a cross-sectional view taken along line VIIB-VIIB illustrated in FIG. 7A.

In the touch pad 900, pseudo button areas 905 to 913 are defined on a surface of a flat portion 901, as illustrated in FIG. 7A. When any place of the flat portion 901 including the pseudo button areas 905 to 913 is pressed, a switch 925 illustrated in FIG. 7B operates.

When a finger presses any one of the pseudo button areas 905 to 913, a device driver calculates a coordinate of a pressed position and determines which pseudo button area is an area with which the finger comes into contact for pressing.

A technology in which the pseudo button areas 911 and 913 are intended to further have a pointer movement function of the touch pad 900, and correspond to a left button and a right button of a mouse button mounted on a notebook PC of the related art, respectively, is disclosed.

However, in the touch pad of the related art described above, when a slide operation in which a surface of a touch pad is lightly traced with the finger so as to move a pointer is performed and then a pressing operation is performed, if a position in which a finger is stopped is in the pseudo button area corresponding to the right button of the mouse button, it is not possible to perform a left button operation. Accordingly, there is a problem in that operability is not good, and for example, a right button operation is unintentionally performed or it is necessary to perform the slide operation again.

### SUMMARY OF THE INVENTION

The present invention provides a touch pad system and a program for touch pad control with good operability in which, when a slide operation is performed and then a pressing operation is performed, a right button operation is prevented from being unintentionally performed regardless of a position in which a finger is stopped for the pressing operation or it is not necessary to perform the slide operation again.

A touch pad system of an embodiment of the present invention includes: an operation member; coordinate output means for detecting a proximity operation of an operation body with respect to the operation member, and performing a coordinate output; pressing detection means for detecting a pressing operation with respect to the operation member; and control means for performing control corresponding to the proximity operation and the pressing operation based on detection results of the coordinate output means and the pressing detection means, in which the control means determines the presence or absence of a slide operation from a change in the coordinate output that is output from the coordinate output means due to the proximity operation, sets a first area in which execution of a first function is determined when the pressing operation is performed with respect to the operation member, and a second area in which execution of the first function or a second function is determined when the pressing operation is performed, and executes the first function if the slide operation is performed prior to the pressing operation and the second function if the slide operation is not performed when the pressing operation is performed in the second area.

Accordingly, when the pressing operation is performed in the second area, the first function is executed if the slide operation is performed prior to the pressing operation, and the second function is executed if the slide operation is not performed. Accordingly, the first function is set as a left button function of the mouse button, and the second function is set as a right button function thereof, and thus, when the slide operation is performed and then the pressing operation is performed, the left button operation can be performed regardless of a position in which a finger is stopped for the pressing operation. Therefore, it is possible to provide the touch pad system with good operability in which the right button operation is prevented from being unintentionally performed or it is not necessary to perform the slide operation again.

Further, a program for touch pad control of another embodiment of the present invention is a program for touch pad control that performs control corresponding to a proximity operation and a pressing operation based on a detection result of coordinate output means and a detection result of pressing detection means, in which the program for touch pad control determines the presence or absence of a slide operation from a change in the detection result of the coordinate output means, sets a first area in which execution of a first function is determined according to the proximity operation and the pressing operation, and a second area in which execution of the first function or a second function is determined when the pressing operation is performed, and executes the first function if it is determined that the slide operation is performed prior to the pressing operation and the second function if it is determined that the slide operation is not performed when it is determined that the pressing operation is performed in the second area.

Accordingly, when it is determined that the pressing operation is performed in the second area, the first function is executed if it is determined that the slide operation is performed prior to the pressing operation and the second function is executed if it is determined that the slide operation is not performed. Therefore, the first function is set as a left button function of the mouse button, and the second function is set as a right button function thereof, and thus, when the slide operation is performed and then the pressing operation is performed, control corresponding to the left button operation can be performed regardless of a position in which a finger is stopped for the pressing operation. Through this control, it is possible to provide the program for touch pad control with good operability in which the right button operation is prevented from being unintentionally performed or it is not necessary to perform the slide operation again.

According to the present invention, it is possible to provide the touch pad system with good operability in which, when the slide operation is performed and then the pressing operation is performed, the right button operation is prevented from being unintentionally performed regardless of a position in which a finger is stopped for the pressing operation or it is not necessary to perform the slide operation again.

### BRIEF DESCRIPTION OF THE DRAWINGS

FIG. 1 is a block diagram illustrating a configuration of a touch pad system according to an embodiment of the present invention;

FIG. 2 is a schematic appearance view of a device to which the touch pad system is applied according to an embodiment of the present invention;

FIGS. 3A and 3B are illustrative diagrams of an operation member of the touch pad system according to an embodiment of the present invention;

FIGS. 4A and 4B are diagrams illustrating pressing detection means of the touch pad system according to an embodiment of the present invention;

FIG. 5 is a schematic view illustrating a first area and a second area set in the operation member;

FIG. 6 is a flowchart illustrating an operation according to a program for touch pad control of the touch pad system according to an embodiment of the present invention; and

FIGS. 7A and 7B are diagrams illustrating a structure of a touch pad of the related art.

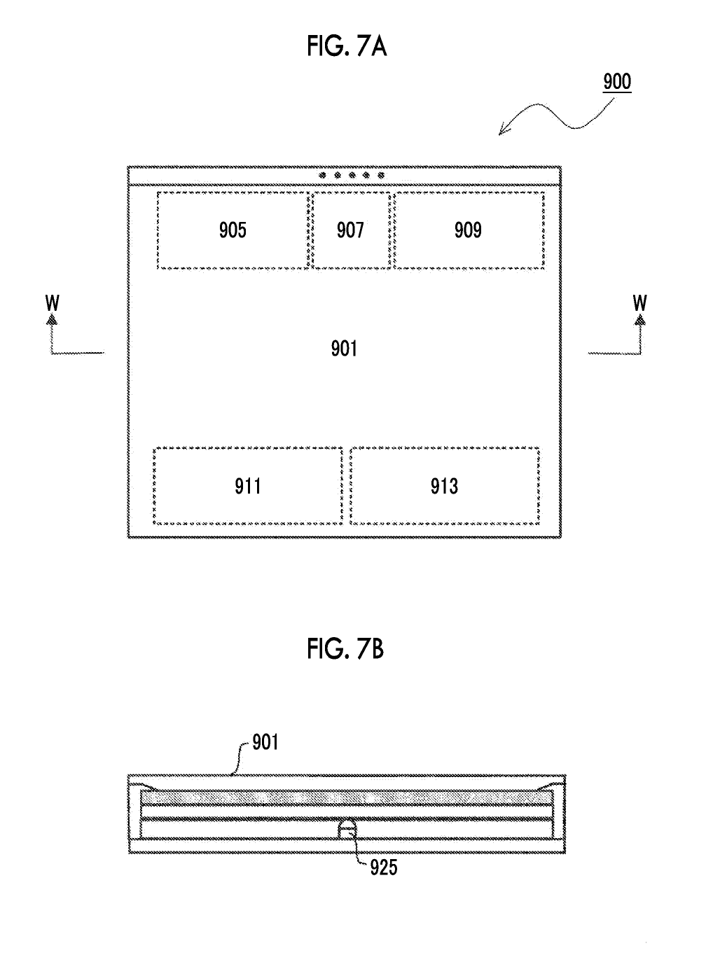

### DESCRIPTION OF THE PREFERRED EMBODIMENTS

### First Embodiment

Hereinafter, a touch pad system and a program for touch pad control in a first embodiment will be described.

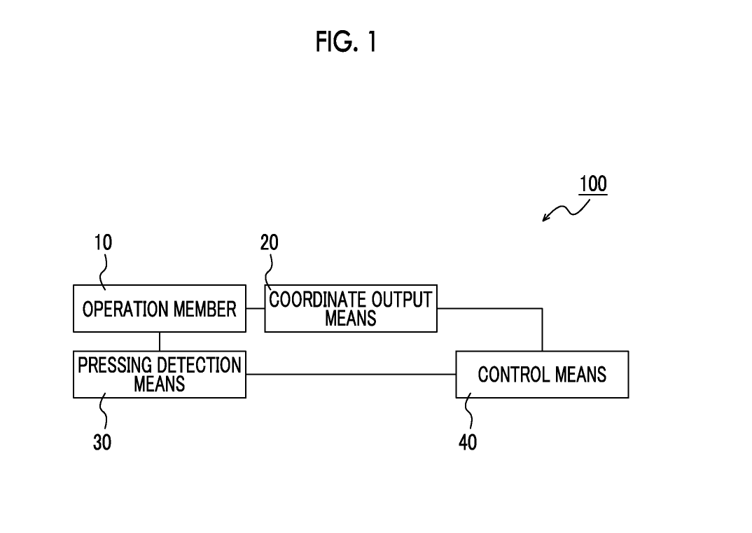

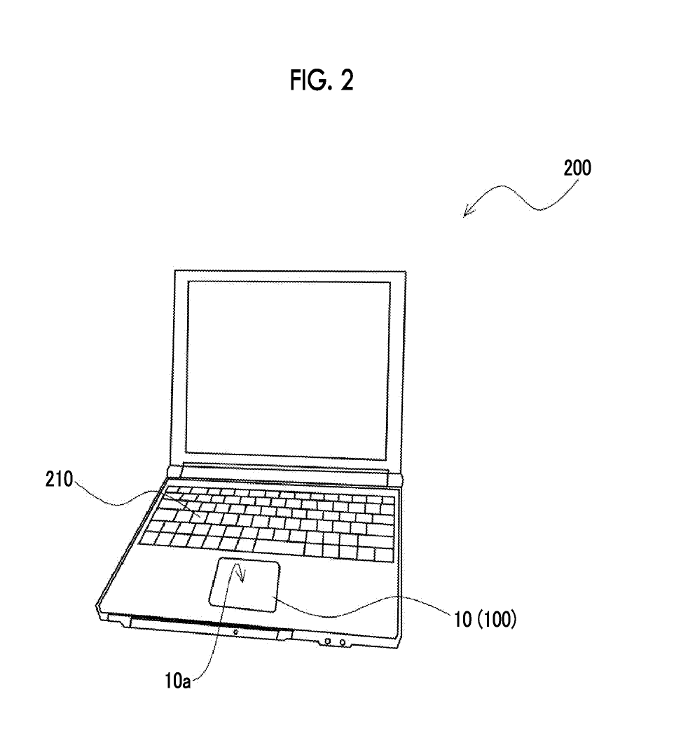

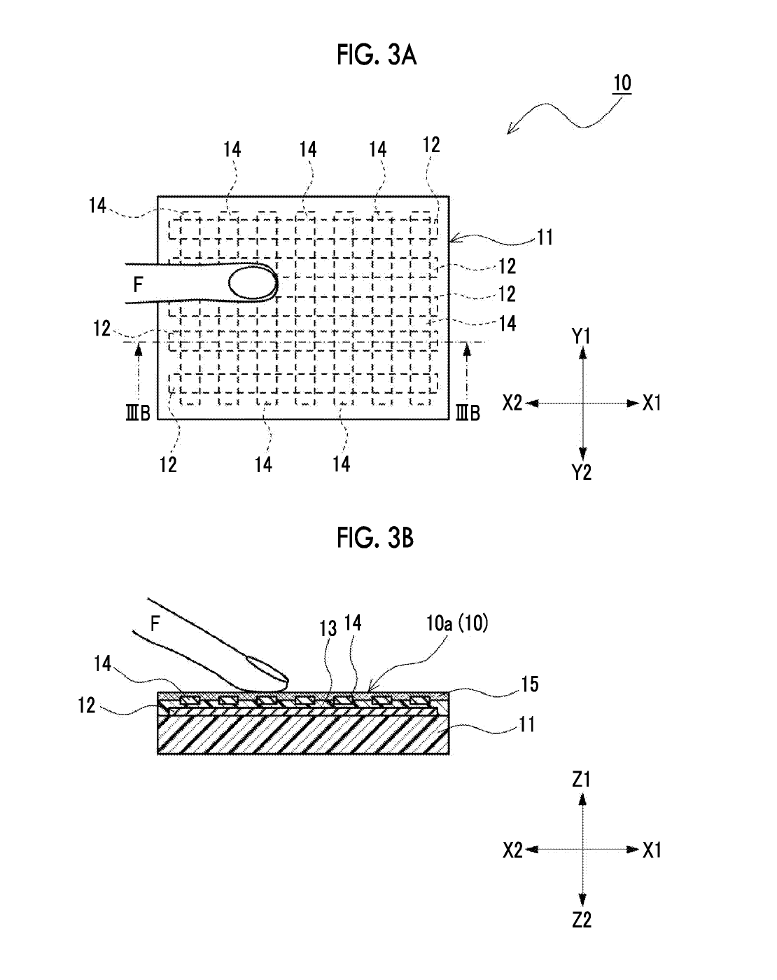

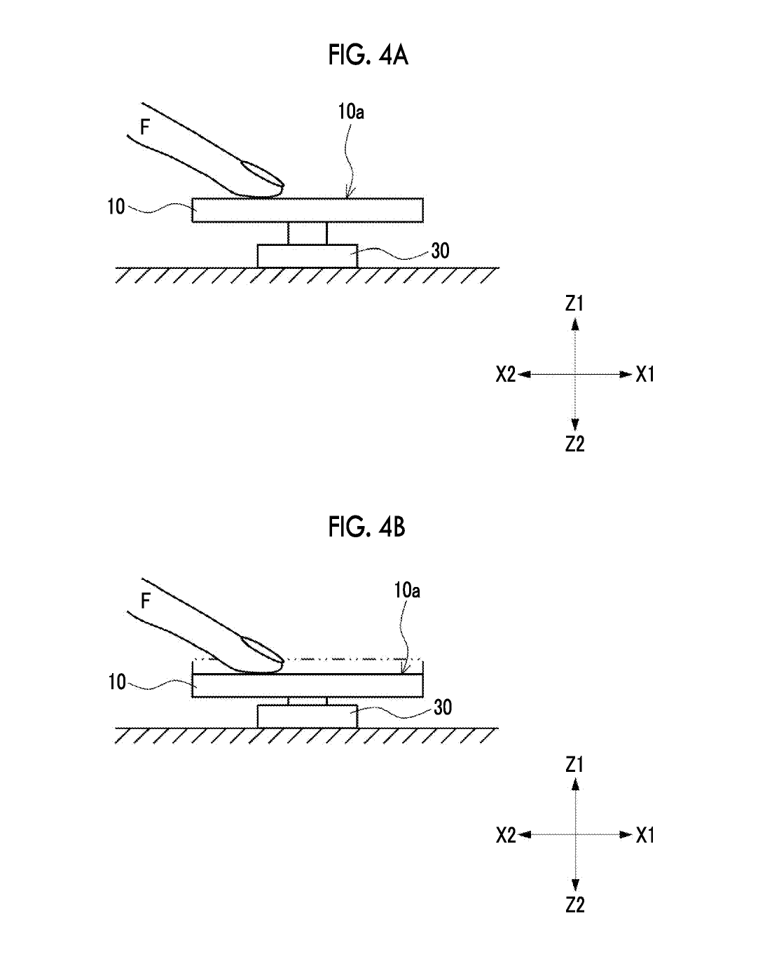

First, a configuration of a touch pad system 100 in this embodiment will be described using FIGS. 1 to 3B. FIG. 1 is a block diagram illustrating a configuration of the touch pad system 100. FIG. 2 is a schematic appearance view of a device 200 to which the touch pad system 100 is applied. FIGS. 3A and 3B are diagrams illustrating an operation member 10 of the touch pad system 100, FIG. 3A is a schematic plan view of the operation member 10, and FIG. 3B is a cross-sectional view taken along line IIIB-IIIB illustrated in FIG. 3A. FIGS. 4A and 4B are diagrams illustrating pressing detection means 30 of the touch pad system 100, FIG. 4A is a schematic view illustrating a state in which a pressing operation is not performed, and FIG. 4B is a schematic view illustrating a state in which the pressing operation is performed.

The touch pad system 100 includes an operation member 10, coordinate output means 20, pressing detection means 30, and control means 40, as illustrated in FIG. 1. Further, in the device 200 to which the touch pad system 100 is applied, the operation member 10 is attached in the center of a palm rest portion provided in front of a keyboard 210 in a state in which an operation surface 10a is exposed, as illustrated in FIG. 2.

In the operation member 10, a plurality of detection electrodes 12 extending in an X1-X2 direction as illustrated in FIG. 3A are formed in a base 11, which is formed of a resin such as a glass epoxy, or glass. Further, a plurality of driving electrodes 14 extending in a Y1-Y2 direction orthogonal to the detection electrodes 12 via an insulating layer 13 interposed between the driving electrodes 14 and the detection electrodes 12 as illustrated in FIG. 3B are formed. Further, a protection member 15 with which a surface in which the detection electrode 12 or the driving electrode 14 is formed is covered is provided, and a surface of this protection member 15 is the operation surface 10a of the operation member 10.

The coordinate output means 20 includes, for example, an ASIC, and is connected to the plurality of detection electrodes 12 and the plurality of driving electrodes 14 provided in the operation member 10 via a plurality of wirings. The coordinate output means 20 detects a coordinate at which an operation body F is performing a proximity operation with respect to the operation member 10 from a change in capacitance between the driving electrode 14 and the detection electrode 12 based on a situation of voltage application to the driving electrode 14 provided in the operation member 10 and a voltage detection situation of the detection electrode 12, and performs coordinate output.

For the pressing detection means 30, a push switch with respect to which a pressing operation can be performed is used. The pressing detection means 30 is arranged on the lower side (Z2 illustrated in FIGS. 4A and 4B) of the operation member 10, as illustrated in FIGS. 4A and 4B. The operation member 10 is supported by an upper side (Z1) of the pressing detection means 30, as illustrated in FIG. 4A, in a state in which the operation body F does not perform a pressing operation with respect to the operation member 10. In this case, the push switch which is the pressing detection means 30 is OFF. When the operation body F performs the pressing operation with respect to the operation member 10, the operation member 10 is moved to the lower (Z2) side as illustrated in FIG. 4B, and the push switch which is the pressing detection means 30 is turned ON. Thus, the push switch which is the pressing detection means 30 is able to detect the presence or absence of the pressing operation with respect to the operation member 10, which corresponds to an ON or OFF state.

The control means 40 includes a CPU (Central Processing Unit; not illustrated), and a memory or timer function. The control means 40 is connected to the coordinate output means 20 and the pressing detection means 30, as illustrated in FIG. 1. The control means 40 performs control corresponding to the proximity operation and the pressing operation based on detection results of the coordinate output means 20 and the pressing detection means 30 according to a program for touch pad control written to the memory in advance. Further, the control means 40 can perform management of a control interval using the timer function, storage of the detection result of the coordinate output means 20 or the pressing detection means 30 and a result of calculation thereof, or the like.

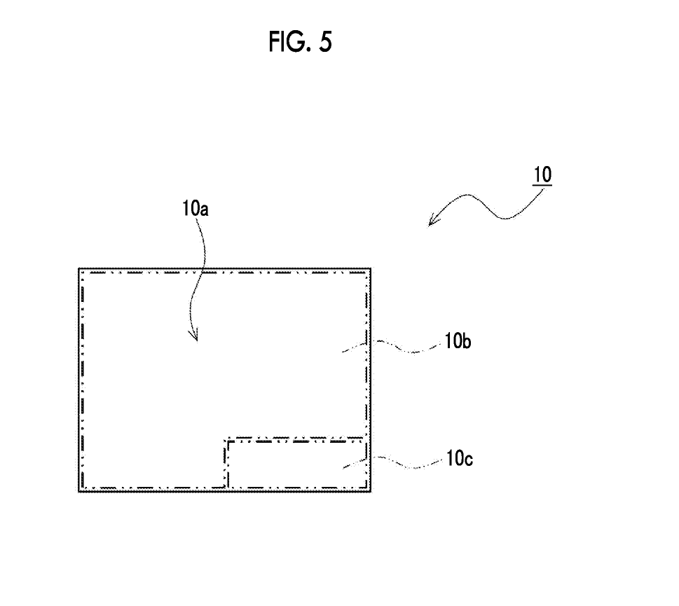

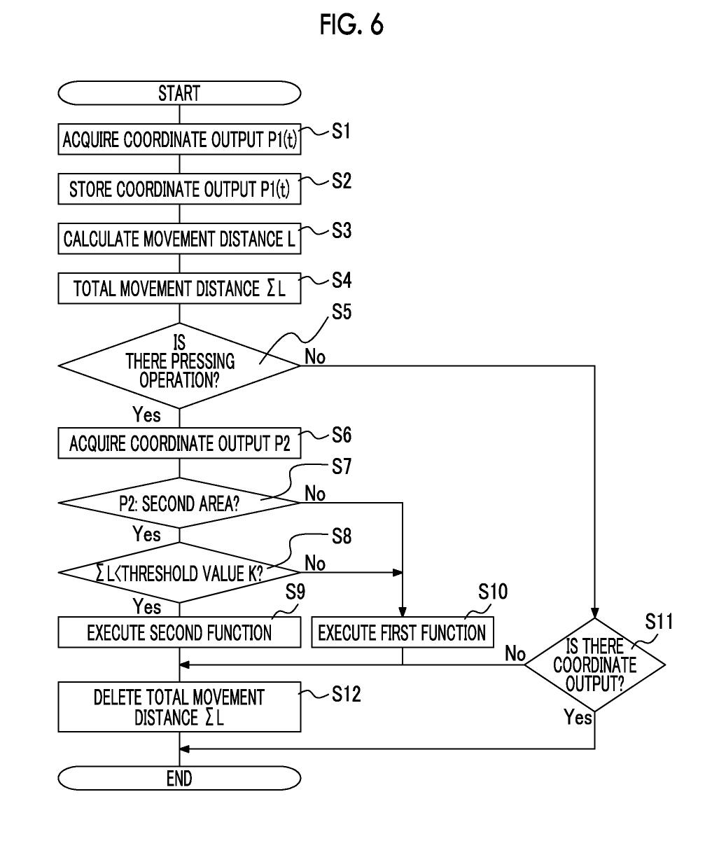

Next, an operation of the touch pad system 100 based on the program for touch pad control in this embodiment will be described using FIGS. 5 and 6. FIG. 5 is a plan view illustrating the operation member 10 and is a schematic view illustrating a first area 10b and a second area 10c set by the control means 40. FIG. 6 is a flowchart illustrating an operation based on the program for touch pad control in the touch pad system 100 according to this embodiment. A process procedure shown in the flowchart of FIG. 6 is regularly repeatedly performed using the timer function or the like built into the control means 40.

As illustrated in FIG. 5, the control means 40 sets the first area 10b in which execution of the first function is determined and the second area 10c in which execution of the first function or the second function is determined when the pressing operation is performed in a range of the operation surface 10a of the operation member 10 in advance, to be associated with the coordinate output that is output from the coordinate output means 20. Further, it is assumed that a left button function of a mouse button is assigned to the first function, and a right button function of the mouse button is assigned to the second function.

The proximity operation is performed with respect to the operation member 10 by the operation body E When a result of detecting a coordinate at which the proximity operation is performed is output as the coordinate output from the coordinate output means 20, the control means 40 starts an operation shown in the flowchart of FIG. 6. In step Si of the flowchart illustrated in FIG. 6, the control means 40 acquires a coordinate output P1(t) from the coordinate output means 20, and proceeds to step S2.

The control means 40 stores the coordinate output P1(t) acquired in step S1 in the memory in step S2, and proceeds to step S3. Further, a coordinate output storage area in which the coordinate output is stored is set in the memory, and at least a predetermined initial value or a previously acquired coordinate output P1(t−1) is stored.

The control means 40 calculates a movement distance L of the operation body F from the previously acquired coordinate output P1(t−1) and a currently acquired coordinate output P1(t) in step S3, and proceeds to step S4. Further, when the initial value is set in the previously acquired coordinate output, the movement distance L is set to “0 (zero).”

In step S4, the control means 40 adds the movement distance L calculated in step S3 to a total movement distance ΣL calculated by a previous time to update the movement distance ΣL, and proceeds to step S5.

In step S5, the control means 40 determines the presence or absence of the pressing operation from the detection result of the pressing detection means 30, and proceeds to step S6 when it is determined that the pressing operation has been performed. Further, the control means 40 proceeds to step S11 when it is determined that the pressing operation is not performed.

In step S6, the control means 40 acquires the coordinate output P2 from the coordinate output means 20, and proceeds to step S7.

In step S7, the control means 40 determines whether the coordinate output P2 acquired in step S6 is from the inside or the outside of the second area 10c set in advance. The control means 40 proceeds to step S8 when it is determined that the coordinate output P2 is from the inside of the second area 10c, and proceeds to step S10 when it is determined that the coordinate output P2 is from the outside of the second area 10c.

In step S8, the control means 40 compares a threshold value K set and stored in advance to determine that the slide operation has been performed with the total movement distance ΣL calculated in step S4. As a result of the comparison, when the total movement distance ΣL is less than the threshold value K, it is determined that the slide operation has not been performed, and the process proceeds to step S9. When the total movement distance ΣL is equal to or more than the threshold value K, it is determined that the slide operation has been performed, and the process proceeds to step S10. Thus, the control means 40 calculates the total movement distance ΣL from a change in the coordinate output P1(t) output from the coordinate output means 20 due to the proximity operation, and determines the presence or absence of the slide operation by comparing the total movement distance ΣL with the threshold value K set in advance.

Step S9 corresponds to a case in which it is determined that the pressing operation has been performed inside the second area 10c in step S7 and a case in which it is determined that the slide operation is not performed prior to the pressing operation in step S8. Therefore, the control means 40 executes a right button function of the mouse button as the second function, and proceeds to step S12.

Step S10 corresponds to the case in which it is determined that the pressing operation has been performed outside the second area 10c in step S7 and the case in which it is determined that the pressing operation has been performed inside the second area 10c in step S7 and the slide operation has been performed prior to the pressing operation in step S8. Therefore, the control means 40 executes the left button function of the mouse button as the first function, and proceeds to step S12.

In step S11, it is determined whether the coordinate output continues to be output since it is determined in step S5 that the pressing operation is not performed. When the coordinate output continues to be output, the process ends since the contact operation continues. When the coordinate output does not continue to be output, the process proceeds to step 12 since the contact operation is stopped.

Step S12 corresponds to the case in which the first function or the second function is performed in step S9 or S10 or the case in which the contact operation is stopped in step S11. Therefore, the control means 40 does not erroneously determine the presence or absence of the slide operation at the time of a next pressing operation, and thus, the control means 40 deletes a value of the total movement distance ΣL so as to be “0 (zero)” and ends the process.

Hereinafter, effects of this embodiment will be described.

The touch pad system 100 of the present embodiment includes an operation member 10, coordinate output means 20 for detecting a proximity operation of the operation body F with respect to the operation member 10, and performing a coordinate output, pressing detection means 30 for detecting a pressing operation with respect to the operation member 10, and control means 40 for performing control corresponding to the proximity operation and the pressing operation based on detection results of the coordinate output means 20 and the pressing detection means 30, and the control means 40 determines the presence or absence of the slide operation from a change in the coordinate output that is output from the coordinate output means 20 due to the proximity operation, sets a first area 10b in which execution of the first function is determined when the pressing operation is performed with respect to the operation member 10, and a second area 10c in which execution of the first function or the second function is determined when the pressing operation is performed, and executes the first function if the slide operation is performed prior to the pressing operation and the second function if the slide operation is not performed when the pressing operation is performed in the second area 10c.

Accordingly, the touch pad system 100 operates to execute the first function if the slide operation is performed prior to the pressing operation and the second function if the slide operation is not performed when the pressing operation is performed in the second area 10c. Accordingly, the first function is set as a left button function of the mouse button, and the second function is set as a right button function thereof, and thus, when the slide operation is performed and then the pressing operation is performed, the left button operation can be performed regardless of a position in which a finger is stopped for the pressing operation. Therefore, it is possible to provide the touch pad system with good operability in which the right button operation is prevented from being unintentionally performed or it is not necessary to perform the slide operation again.

Further, a program for touch pad control in the present embodiment is configured to perform control corresponding to a proximity operation and a pressing operation based on a detection result of the coordinate output means 20 and a detection result of the pressing detection means 30, to determine the presence or absence of the slide operation from a change in the detection result of the coordinate output means 20, set a first area 10b in which execution of the first function is determined according to the proximity operation and the pressing operation, and the second area 10c in which execution of the first function or the second function is determined when the pressing operation is performed, and execute the first function if it is determined that the slide operation is performed prior to the pressing operation and the second function if it is determined that the slide operation is not performed when it is determined that the pressing operation is performed in the second area 10c.

Accordingly, when it is determined that the pressing operation is performed in the second area 10c, the first function is executed if it is determined that the slide operation is performed prior to the pressing operation and the second function is executed if it is determined that the slide operation is not performed. Therefore, the first function is set as a left button function of the mouse button, and the second function is set as a right button function thereof, and thus, when the slide operation is performed and then the pressing operation is performed, control corresponding to the left button operation can be performed regardless of a position in which a finger is stopped for the pressing operation. Through this control, it is possible to provide the program for touch pad control with good operability in which the right button operation is prevented from being unintentionally performed or it is not necessary to perform the slide operation again.

While the touch pad system and the program for touch pad control according to the embodiment of the present invention have been described above in detail, the present invention is not limited to the above-described embodiment and can be changed and embodied in various ways without departing from the gist. For example, the present invention may be changed and embodied as follows, and these embodiments also belong to the technical range of the present invention.

(1) In this embodiment, while the example in which the control means 40 includes a CPU and a memory or timer function has been described, an MPU (Micro Processing Unit) may be used for a configuration. In such a case, it is preferable for the program for touch pad control to be installed as firmware. Further, the control means corresponds to a calculation device or a storage device of a notebook PC, and the program for touch pad control may be configured as a program of a driver that is executed by the calculation device of the notebook PC.

(2) In this embodiment, while the example in which the first area 10b in which execution of the first function is determined and the second area 10c in which execution of the first function or the second function is determined when the pressing operation is performed in a range of the operation surface 10a of the operation member 10 are set has been shown and described, the present invention is not limited to two functions and two areas and three or more functions and areas may be set.

(3) In this embodiment, while the example in which the left button function of the mouse button is assigned to the first function and the right button function of the mouse button is assigned to the second function has been shown and described, the functions may be changed and performed according to a device to which the touch pad system is applied.

It should be understood by those skilled in the art that various modifications, combinations, sub-combinations and alterations may occur depending on design requirements and other factors insofar as they are within the scope of the appended claims of the equivalents thereof.

1. A touch pad system comprising:
an operation member having an operation surface;
a coordinate output unit configured to detect a proximity operation of an operation body with respect to the operation member, and to output a coordinate corresponding a position on the operation surface at which the proximity operation is performed;
a pressing detection unit configured to detect a pressing operation of the operation member on the operation surface; and
a control unit configured to perform a function corresponding to the proximity operation and the pressing operation detected by the coordinate output unit and the pressing detection unit, respectively,
wherein the operation surface includes:
a first area in which a first function is performed if the pressing operation of the operation body is detected therein; and
a second area in which the first function or a second is performed if the pressing operation of the operation body is detected therein, depending on the proximity operation of the operation body prior to the pressing operation,
and wherein the control unit is further configured to:
obtain the coordinate of the detected pressing operation;
determine a presence or absence of a slide operation of the operation body over the operation surface from a change in the coordinate output from the coordinate output unit;
execute the first function if the coordinate of the detected pressing operation is within the first area of the operation surface;
execute the first function if the coordinate of the detected pressing operation is within the second area and the slide operation is performed prior to the detected pressing operation; and
execute the second function if the coordinate of the detected pressing operation is within the second area and the slide operation is not performed prior to the detected pressing operation.

2. A method for controlling a touch pad having an operation surface, the method comprising:
setting a first region and a second region on the operation surface;
detecting, using a coordinate output unit, a proximity operation of an operation body over the operation surface and obtaining a coordinate corresponding a position on the operation surface at which the proximity operation is performed;
detecting, using a pressing detection unit, a pressing operation of the operation body on the operation surface;
detecting a presence or absence of a slide operation of the operation body over the operation surface from a change in the coordinate output from the coordinate output unit;
executing a first function if the coordinate of the detected pressing operation is within the first area;
executing the first function if the coordinate of the detected pressing operation is within the second area and the slide operation is performed prior to the detected pressing operation; and
executing the second function if the coordinate of the detected pressing operation is within the second area and the slide operation is not performed prior to the detected pressing operation.

3. The touch pad system of claim 1, wherein the first function corresponds to a left button function of a mouse, and the second function corresponds to a right button function of the mouse.

4. The touch pad system of claim 1, wherein the slide operation is determined based on a distance for which the operation body has traveled prior to the detected pressing operation.

5. The method of claim 2, wherein the first function corresponds to a left button function of a mouse, and the second function corresponds to a right button function of the mouse.

6. The method claim 2, wherein the slide operation is determined based on a distance which the operation body has traveled prior to the detected pressing operation.
